(19) United States
(12) Patent Application Publication
(10) Pub. No.: US 2024/0188583 A1
(43) Pub. Date: Jun. 13, 2024

(54) FILLED GUMMIES AND FORMULATIONS THEREOF

(71) Applicants: Santiago Martinez Torres, Bogotá (CO); Kevin Mateo Cañas Triana, Bogotá (CO); Andrea Ocampo Salgado, Bogotá (CO)

(72) Inventors: Santiago Martinez Torres, Bogotá (CO); Kevin Mateo Cañas Triana, Bogotá (CO); Andrea Ocampo Salgado, Bogotá (CO)

(21) Appl. No.: 18/531,682

(22) Filed: Dec. 6, 2023

Related U.S. Application Data
(60) Provisional application No. 63/430,686, filed on Dec. 7, 2022.

(51) Int. Cl. A23G 3/54; A23L 29/212; A23L 29/231; A23L 29/30; A23L 33/15

(52) U.S. Cl. CPC A23G 3/54; A23L 29/212; A23L 29/231; A23L 29/30; A23L 33/15

(57) ABSTRACT

The invention provides liquid-filled chewable gummy compositions for the oral delivery of nutritional supplements and/or pharmaceuticals. The chewable composition includes a delivery vehicle and an active ingredient incorporated therein. The delivery vehicle may include an organic or non-organic gummy candy including a binding agent, sweetener, flavoring, and/or coloring. The active ingredient may include a predetermined amount of any combination of nutraceuticals, vitamins, minerals, pharmaceuticals, antioxidants, soluble and insoluble fiber, herbs, plants, probiotics, prebiotics, amino acids, fatty acids, digestive enzymes, dietary supplements, or any other health promoting ingredient. The delivery vehicle may also include a predetermined amount of at least one nutritional supplement and/or pharmaceutical compound.

This application claims the priority benefit under 35 U.S.C. section 119 of U.S. Provisional Patent Application No. 63/430,686 entitled “Filled Gummies And Formulations Thereof” filed on Dec. 7, 2022; and which is in its entirety herein incorporated by reference.

### FIELD OF THE INVENTION

The invention relates generally to a chewable dietary supplement, and more particularly to a chewable composition with a liquid-filled center for the oral delivery of dietary supplements and pharmaceutical compounds and/or active ingredients and a method for manufacturing the same. The invention also relates to the field of confectionery, in particularly center filled confectionery, more in particularly to center filled confectionery wherein the filling comprises an active ingredient.

### BACKGROUND OF THE INVENTION

A confectionery gel (CG) consists of high sugar components of sucrose and glucose syrup, combined with gelling components such as starch, gelatin, or pectin, along with a food acid, flavourings and colourings. Common CG products include “jelly snakes,” “jelly babies,” “jelly beans,” and form a portion of the lucrative confectionery market; however, there are continual consumer demands for more interesting and innovative products that have new and exciting textures, flavors and appearances.

Recently, chewable supplements have been manufactured and sold in the form of a gummy candy supplement. Now a selection of vitamins and other dietary supplements are being manufactured and sold in a chewable gummy form, including both children and adult supplements. The introduction of gummy supplements into the marketplace has been particularly helpful in getting children to take daily vitamin supplements. For adults that do not like swallowing pills, gummy supplements have also provided a non-pill alternative for adults to get their daily vitamin requirements.

Although gummy candy was first introduced in 1920 as “gummy bears,” it was not until very recently that gummy candy was first utilized, by Hero Nutritionals, LLC, San Clemente, Calif., as a delivery system for dietary supplements. Traditional gummy candy is made from a gelatin base, which is similar to the base found in soft caramels, marshmallows, foam-filled wafers, licorice, wine gums, pastilles, chocolate coated mallows and a host of other sweets. Gelatin is a protein derived from animal tissue that forms thick solutions or gels when placed in water. When used in gummy candy, gelatin serves as a binding agent that gives the candy its elasticity and desired chewy consistency.

In addition to gelatin, gummy candies are generally made from a blend of water, sweeteners (e.g., corn starch, corn syrup, and/or sugar), flavors, and colors. When mass produced, a gelatin base or stock is first mixed and pumped into a special candy cooker that cooks the gelatin base by steam. Then, the cooker pumps the gelatin base into a vacuum chamber to remove excess moisture. From the vacuum chamber, the cooked candy moves to a mixing station where colors, flavors, acids, and fruit concentrates are mixed into the cooked candy. Next, a starch molding machine, commonly known as a mogul, pumps the candy stock into starch filled mold boards that shape the candies. After curing, the gummies are removed from the molds and then packaged, delivered, and sold.

Gummy vitamins have become a favorite among children as well as adults. Gummy vitamins have grown in popularity because of their unique combination of sweetness and nutritional value. The popularity of gummy vitamins has rivaled those of other confectionary products. One such rival is liquid-filled chewing gum. Liquid-filled gums, such as Chewels®, Tidal Wave®, Freshen Up®, and most recently Trident Splash®, generally include a solid, chewing gum-like outer portion or shell, and a soft or liquid center-typically a flavored liquid have an syrup-like consistency. Liquid-filled gums are popular because they produce an initial strong sweet taste as the liquid center is quickly released into the oral cavity (i.e., initial liquid “burst”) when the gum is consumed. Thus, liquid-filled gums are effective in delivering their active ingredients, i.e., liquid sweetener, into the oral cavity of a consumer.

Gels exist in many material systems including diverse media such as polymers, plant and animal tissues, and food. The majority of foods are, or consist of gels (Yuryev, V. P. et al. 1995. Phase state of starch gels at different water contents. Carbohyd. Polym., 26(1): 43-46) and gels found in foods provide easily recognized, although widely varying textures (Edwards, S., 1987. “Gels networks in practice and theory”. In Food Structure and Behaviour, Edited by: Blanshard, J. and Lillford, P. 1-12). National tastes can often dictate which are the gelling ingredients of choice to provide pleasing textures to consumer markets (Edwards, W. P. 2000. The Science of Sugar Confectionery, 166Cambridge: The Royal Society of Chemistry). There are several definitions of a gel within literature. Hermans (Hermans, P. H. 1949. “Gels”. In Colloid Science, Edited by: Kruyt, H. Vol. II, 483-651) stated that a gel must be: (1) a coherent two component system formed by a solid substance finely dispersed, or dissolved in, a liquid phase that also (2) exhibits solid-like behaviour under mechanical forces. Another view put forward is that all gels are solid, as they are self-supporting and can recover elastically after deformation, however some gels may have some unrecovered stresses that can be present after deformation, and gels may deform in a brittle manner, such as in agar or kappa-carrageenan gels (Stainsby, G., Gelation and Gelling Agents. Proceedings of the UK Symposium on Gelation and Gelling Agents. Oct. 20, 1971). Flory (Flory, P. J. 1953. Principles of Polymer Chemistry, 672Ithaca: Cornell University Press.) suggested that gels consist of polymeric molecules crosslinked to form a tangled interconnected network immersed in a liquid medium. Djabourov and LeBlond (Djabourov, M. and LeBlond, J. 1987. Thermally reversible gelation of the gelatin-water system. ACS Sym. Ser., 350: 211-223) mentioned that in a gel both the dispersed component and the solvent should extend continuously throughout the whole system, each phase being interconnected, which is similar to the theory proposed by Flory (Flory, P. J. 1953. Principles of Polymer Chemistry, 672Ithaca: Cornell University Press.) A gel has also been described as a giant polymer made up of molecules that are branched in three dimensions and form a lattice.

Obviously there are several types of gels and they are commonly classified into two main groups—chemical and physical gels, which are distinguished by the differences in nature of the bonds linking the gels' molecules together (Peyrelasse, J., Lamarque, M., Habas, J. P. and El Bounia, N. 1996. Rheology of gelatin solutions at the sol-gel transition. Phys. Rev. E., 53(6): 6126-6133). Chemical gels usually are covalently crosslinked gels, whilst physical gels consist of chains which are “physically” (non-covalently) crosslinked into networks (Kavanagh, G. M. and Ross-Murphy, S. B. 1998. Rheological characterisation of polymer gels. Prog. Polym. Sci., 23(3): 533-562 and Burchard, W. and Ross-Murphy, S. B. 1990. “Introduction: Physical gels from synthetic and biological macromolecules”. In Physical Networks—Polymers and Gels, Edited by: Burchard, W. and Ross-Murphy, S. 1-14).

The crosslinks in physical gels are of small but finite energy and/or finite lifetime, and can be found in biological and synthetic polymers. In biopolymer gels the crosslinks are formed by physical gel mechanisms such as Coulombic, dipole-dipole, van der Waal's, charge transfer, hydrophobic, and hydrogen bonding interactions. The term physical gel is often assumed to imply thermoreversibility in the gel, such as in the case of gelatin, although this is not the case in every physical gel system (e.g. casein gels) (Kavanagh, G. M. and Ross-Murphy, S. B. 1998. Rheological characterisation of polymer gels. Prog. Polym. Sci., 23(3): 533-562.

Most food gel products in the market today are in fact composite gels, containing two or more gelling components. Most components contribute to structure and physical properties of food, with the two main structural materials being proteins and polysaccharides. Biopolymer mixtures are used in many industries, including food, to impart specific flow behaviours, textures, appearances, and where required, tactile and mouthfeel properties, to products. As a consequence of the wide use of biopolymer mixtures in food, these types of systems have been greatly researched, but it is only recently that biopolymer phase separation in composite gels and the effects of this on composite gel properties have been studied. Most food components have limited miscibility on a molecular level and tend to form multicomponent heterophase and non-equilibrium dispersed systems.

For polymers dissimilar in shape or structure, segregation leads to a reduction of the polymer concentration near the other type of polymer particle. Once a critical polymer concentration is exceeded, this leads to phase separation. Interactions of proteins and polysaccharides range from complete segregation to complexation. These interactions can greatly affect mechanical gel properties whilst chain structure, molecular weight and composition are important for structure. Often, linear polysaccharides are more incompatible with proteins than branched polysaccharides due to rigidity and the presence of less independently moving macromolecular segments and lower mixing entropy than in flexible branched polymers. The differences in hydrophobicity in proteins and polysaccharides are of great importance for phase equilibrium in protein-polysaccharide-water systems. The level of phase separation, and shape and appearance of phase components, in these systems depends on polymer concentration and the compatibility of the biopolymers.

Phase separation in composite gels is a result of thermodynamic incompatibility of gel components. Phase separation is entropically unfavourable, but enthalpically advantageous as molecules prefer like molecules. Temperature changes can also affect biopolymer phase separation, as well as pH and shear. Interfacial tension between gel phases is important in determining biopolymer composite behaviour, whilst thermodynamic incompatibility and complex formation by food hydrocolloids can greatly affect mechanical and other physicochemical gel properties. It has been possible to apply synthetic polymer blending laws to food gel composites, in order to predict and quantify mechanical behaviour of such composites.

Confectionery gels (CGs) are often high sugar systems, with one or more gelling components, which are chosen for their textural attributes to give firmer or softer textures to the CGs. The ingredients are formed into a molten material that can be moulded into many different shapes. The aforementioned definitions of gels and composite gels refer more to the conventional ideas of a biopolymer gel system made in an aqueous environment. Recent studies show that on the addition of sugars to such a system, the morphology of the high solid network is distinctly different from that of the aqueous system. This means that the standard concepts of gelation, which apply in aqueous systems are no longer valid in CG systems. However, the aqueous gel system model could be valid if a non-nutritive sweetener is used in a sugar-free CG formulation. This type of product could have a viable market as obesity in children is an increasing problem worldwide.

In the gelling of aqueous biopolymer systems, network formation is governed by some important characteristics of the system which are: (1) the minimum critical gelling concentration, which is the minimum concentration of biopolymer that allows gel networks to form; and (2) the concentration of coil overlap and entanglement of biopolymer chains, which affects density of the network. These characteristics are no longer the main influence on biopolymer gel network formation once sugars are introduced into the system, as is the case in confectionery gels. Sugars change morphology of single biopolymer gel systems, as well as affecting phase separation characteristics in mixed biopolymer gel systems. The major textural properties of CGs are imparted by the gelling components used, such as starch or gelatin. The sugar co-solutes are not part of the polymer network in the confectionery gels but can greatly contribute to formation and behaviour of CGs.

Studies of single biopolymer systems containing sugar have shown that in polysaccharides, such as starch that as sugar concentration approaches levels found in confectionery gels, chain-chain association is reduced. Sugars tend to destabilize polysaccharide gel networks at levels of 40-60% sugars, but increase gelatin gel networks at these levels of sugar.

In aqueous systems, gelatin gels appear featureless, but upon addition of sugar they separate into sugar-rich and gelatin-rich phases, showing high biopolymer aggregation. In aqueous systems, polysaccharides show fibrillar network structures, but upon addition of sugar some of these features are lost. This is due to the threshold of thermodynamic stability of structure formation for polysaccharides being exceeded at these levels, and considerable parts of the network “dissolving” in the saturated sugar environment. Thermodynamic stability of gelatin gel network formation is increased at 40-60% sugar and continues to increase at levels above this.

In mixed biopolymer systems phase separation is governed by critical polymer concentration, polymer shape, and compatibility of the biopolymers present. The extent of mixing is governed by the “Flory-Huggins interaction parameter,” which is dependent on solvent quality and volume as well as polymer concentration and size. Altering the quality of the solvent (e.g., adding sugar to water), results in changes to the extent of mixing in the mixed biopolymer system. This leads to mixed biopolymer systems that contain sugars having a different morphology to those formed in an aqueous environment.

### Confectionery Gel Formulations

A range of gelling agents can be used in the manufacture of confectionery gels, which include: agar, starch, pectin, alginates, gelatin and gums. However, the majority of gel confectionery consists primarily of sucrose, glucose syrup, starch, gelatin and water, with a number of minor components including food acids, flavourings, and colourings. Pectin may also be used as a gelling agent.

### Sucrose and Glucose Syrup

Sucrose used in food is often in granule form and is used as a sweetener. It is often used in concert with glucose syrup, as the syrup can enhance sucrose solubility and retard sucrose crystallization in food products. It serves to contribute to the texture and sensory properties of the gels and may be used to increase product bulk or weight, giving body or mouthfeel to the product. The form of sucrose used in jelly and gum confectionery manufacture is non-crystalline.

Glucose syrups refer to products with a dextrose equivalent (DE) of between 20 and 80 (where 100 indicates pure glucose and 0 indicates no glucose). Products with a DE of less than 20 are termed maltodextrins, and those with a DE of greater than 80 are called hydrolysates or hydrols. Glucose syrup is specified by its DE, carbohydrate composition, solids, and sulphur dioxide content in order to allow manufacturers to produce a product exacting to customer requirements. Traditionally, 42DE glucose syrup is used in confectionery to prevent sucrose crystallization to meet the requirement of confectionery that it must not undergo any change in physical properties during storage. Use of higher viscosity glucose syrup (lower moisture or higher DE) will slow sucrose molecule migration and inhibit graining.

Glucose syrup is essentially shelf-stable and no preservatives need to be added to prevent microbial growth, due to the high dissolved solids content which reduces the water activity to below the level required for microbial growth. Because confectionery must not undergo fermentation, mould growth or other microbiological spoilage during a long storage life, glucose syrup also aids in promoting a lower water activity in confectionery gels, thus preventing microbial growth. Glucose syrup is used in the production of jelly and gum confectioneries, where its principal role is as a sweetener, although it also contributes to texture and microbial stability, as well as stabilizing other ingredients, e.g. sucrose or gelatin. The gelling agents (e.g., starch, gelatin) in CGs usually make up approximately 10% of the food gel, and the rest consists of glucose syrup and sucrose. Confectionery products can often contain more glucose syrup than sucrose.

### Water

Water is a major constituent in many foods, supporting chemical reactions and acting as a reactant in hydrolytic processes, so removing water or binding it by increasing the concentration of common salt or sugar in foodstuffs inhibits many reactions and retards micro-organism growth, aiding to improve shelf life of the food product. The physical interaction of water with proteins, polysaccharides, lipids, and salts can contribute significantly to food texture, as foods tend to become plastic when their hydrophilic components are hydrated. The water content can affect glass transition temperature of a food (the temperature where the material goes from glassy to rubbery behaviour). In confectionery gels, water often acts as a plasticizer to aid gel formation.

Studies have shown bound water values in sucrose/starch/gelatin systems which were: sucrose, 0.05 g/gDM; starch, 0.26 g/gDM; gelatin, 0.44 g/gDM, where g/gDM denotes grams of water per gram of dry material. Gelatin has the highest affinity for water when combined with sucrose and starch, and hence requires it to hold its integrity. The physical state of metastable foods can depend on composition, temperature, and storage time. Water can affect their properties, causing them to be glassy, rubbery, or viscous by altering glass transition temperature. Variations in moisture content can lead to quality variations such as premature crystallization, stickiness, accelerated rancidity, lack of body, difference of chew, hardness, poor handling on forming and cutting machines, and product flaws in surface texture.

### Starch

Starch is present in most plant tissues, laid down in granular form in defined cells, as a storage carbohydrate. The major botanical sources of industrial starch are tubers, grains and pulses, with the composition and place of storage of the granules, as well as granule shape and size being specific to the plant source. Starches from various origins have characteristic properties that are related back to granule size distribution.

In addition to its role in plant physiology, starch is the most important source of carbohydrates in human nutrition and is widely used, alone or in conjunction with other gelling agents, to thicken and bind foods, and to provide a wide range of jelly and gum products. Native and modified starches are important ingredients of many fabricated foods and are often added to semisolid food products to contribute to their structure, and thus improve fat and water-holding properties.

Starch granules consist of starch, moisture and small amounts of lipids and protein. The starch consists of two main components: amylose and amylopectin. Amylose is a predominantly linear α(1-4)-glucan, whereas amylopectin is a highly-branched molecule consisting of an α(1-4)-glucan chains with α(1-6) branch points. The proportions of amylose and amylopectin in the starch granules, as well as structure of the molecules (e.g. average molecular weight, frequency of branching in amylopectin, naturally occurring level of phosphorylation) also depends on plant source.

The role of starch in confectionery gels is to provide the base of the gel structure, and hence many of the gels' textural characteristics. Confectionery gels often contain “thin boiling starches.” These starches are formed by adding a small amount of acid to a starch suspension and heating at a temperature below the starch gelatinization temperature producing starch hydrolysis. When the required degree of chain concision is achieved, the mix is neutralized and the starch filtered off and dried.

The acid hydrolyses some bonds within the starch, leading to a less linked structure and a reduction in molecular weight of some of the chains. This causes the starch granules to be readily soluble in boiling water and disintegrate when cooked to give a lower hot paste viscosity and higher gel viscosity than non-acid modified starches. This type of chemical modification is done to alter the nature of the interactions between polysaccharide chains in the starch. The differences between native and acid modified starches are varied depending on the acid concentration used as well as time for acid hydrolysis. Acid-thinning can “roughen” the surface of starch granules, as well as decrease granule amylose content, as amylose is more easily cleaved by acid hydrolysis than amylopectin. This causes a drop in crystallinity of the starch, and hence a more amorphous material, which causes starch processing for food applications to be easier.

Starch gelatinization is often a major step in starch processing and is loosely termed as a loss of starch crystallinity, coupled with granule swelling. Starch gelatinization occurs when aqueous suspensions of starch granules are heated to above their gelatinization temperature Tgel, then cooled to form a rubbery gel. When suspended in cold water, air-dried starch granules swell increasing in diameter by 30-40%. When heating is applied to these swollen granules, irreversible changes occur at Tgel, for native starches, often 60-70° C. at 30% moisture. At Tgel starch granules swell further, and amylose begins to leach out of the granules. On cooling, the amylose forms a gel network, whilst amylopectin remains in granules during moderate cooking. Starch gels can be composite gels as the matrix and granules have distinct, different properties. Swollen granules are remarkably elastic and give textural body to the gel. Depending on severity of processing and the starch source, starch gels can have varying structures, including: (1) amylose with water entrapped in a three dimensional network; (2) highly swollen and fragmented granules present in a gel matrix; (3) highly swollen and intact granules in a gel matrix; and (4) unswollen and intact granules.

On cooling and re-melting of starch gels, they have been found to consist of a crystalline phase and two immiscible liquid phases. However, this may be dependent on moisture content. At high water contents (>70%) starch gels are biphasic, whilst at low water contents (15-40%) they are monophasic. Amylose and amylopectin can phase separate in starch gels. In acid-thinned starch the gelatinization behaviour is altered depending on the native starch source. In the case of barley and maize starches, acid modification can weaken gel formation if heating is to 90° C., with the weakness due to increased amounts of amylopectin in the continuous phase of hydrolyzed starch pastes; heating hydrolyzed barley starch to 98° C. can overcome this problem as the amylose in the granules is liberated more easily.

The gelatinization temperature and the breadth of the gelatinization endotherm (range of temperatures over which starch is gelatinizing) have been shown to increase on acid hydrolysis of starch. Acid modification has been found to increase solubility and gel strength and decrease viscosity of starches. The viscoelastic properties of starches are also affected by acid hydrolysis. The gel of acid modified oat starch, although less rigid, was more elastic than the corresponding native starch gel.

Many factors affect the process of starch gelatinization and gel formation and so starch gelatinization must be carefully controlled to give a product with preferred consumer attributes, such as texture. Water concentration affects the heat treatment required to gelatinize starch. Starch requires approximately 30% moisture to fully gelatinize, any lower and the gelatinization extent reduces whilst the gelatinization temperature, Tgel, will rise. Some studies have shown that the temperature profile of the starch gelatinization process, and the moisture present, can be used to control the degree of gelatinization, with little effect on final mechanical properties.r can also affect starch gelatinization. Sugar type and concentration can have several effects, with the most important being to raise starch Tgel. In limited water (<30%), starch Tgel increases with decreasing moisture content. When sugar is dissolved in the water being used for gelatinization, part of the water is bound by the sugar, effectively decreasing the moisture content, leading to an increased starch Tgel.

It has been proposed that upon reduction of available water, a point is reached at which the limited extent of starch granule swelling is insufficient to disrupt the starch granule completely. Adding 12% or 24% sucrose has been found to delay swelling of wheat starch granules at up to 50° C.; above 50° ° C. amylose leakage and granule fragmentation is still delayed, but swelling is accelerated. There are several theories as to why sugars inhibit starch gelatinization, and how and where the sugar acts to inhibit starch gelatinization. One theory is that sugar molecules interact with starch granule amorphous regions and increases energy required to melt them, while another theory is that sugar displaces water inside the starch granules, therefore inhibiting one of the promoters of starch gelatinization. Sugars are also thought to stabilize crystalline regions in the starch and hence immobilize water molecules, hindering starch gelatinization.

In gelled starch, sugars tend to help stabilize the structure, inhibiting chain reorganization (also known as recrystallization or retrogradation), where starch molecules reorganize into their crystalline form, though they do not achieve the structure found in the native starch granule. Waxy maize and wheat starches have been found to be the more sensitive to this effect. The order of stabilizing effect provided by different sugars is sucrose>glucose>fructose.

### Gelatin

Gelatin is a thermoreversible gel formed in aqueous solvents through lowering the temperature. It is derived from collagen via controlled acid or alkaline hydrolysis. Collagen may come from hide, bone, or other collagenous material. Commonly, the collagen used is of bovine (cow), porcine (pig), or piscine (fish) origins. The properties of the gelatins derived are affected by the source, age and type of collagen. Gelatin has a role as a gelling agent, providing texture and water binding properties to food materials. Like starch, it is one of the most widely studied functional biopolymers. on the collagen source, and the extraction process used, both of which affect molecular weight of the gelatin product.

### Composition and Structure of Gelatin

A typical gelatin consists of 14% moisture, 84% protein and 2% ash. The protein portion consists of several different amino acids. The major amino acids present are glycine, proline and hydroxyproline.

These amino acids are arranged in gelatin gels to form long molecular chains, similar to the collagen source from whence they came. These chains then form structures, which then interact to lead to the overall gelatin gel network structure. Gelatin molecules contain repeating sequences of glycine-X-Y triplets, where X and Y are frequently proline and hydroxyproline amino acids. The glycine is said to be responsible for chain flexibility. These sequences lead to a triple helical structure in gelatin and its ability to form gels where helical regions form in the gelatin protein chains immobilizing water. This triple helix structure is synonymous with many proteins. The basic macromolecular unit of collagen in which the individual chains are wound in a gentle superhelix around a common molecular axis, which to some extent carries through to the gelatin structure. These helices are stabilized by hydrogen bonds perpendicular to their axes. The triple helices interact via secondary forces to create a three-dimensional network. The arrangement and appearance of this network is dependent on processing methods by which the gelatin becomes a gel.

### Gelation of Gelatin

Gelatin can undergo thermoreversible gelation at protein concentrations >2-3%. The sol-gel transition of gelatin has been studied extensively and has been shown to be affected by many different factors. A gelatin solution, which can eventually produce a gelatin gel, is normally formed through either an indirect solution or a direct solution. To form an indirect solution, gelatin particles are added to cold water just ensuring that particle wetting and that the granules swell until a soft friable mass is formed. A gelatin solution is formed when this mass is heated to 50-60° C. Constant stirring of the solution aids dissolution.

Forming a direct solution is the more common method, since it eliminates the cold soaking stage in the indirect solution method, thereby reducing production time. This method requires higher temperatures (60-80° C.) and high speed agitation to prevent clumping when gelatin is added to the water. Water is heated, and stirred vigorously enough to create a vortex. Gelatin powder or granules are then slowly added, with stopping and stirring to ensure even dispersion and dissolution. After all the requisite gelatin is added, extra stirring is carried out to ensure complete dispersion of the gelatin in the water. There are several theories about how formation of gelatin gels occurs. Many of these may be valid for the types and concentrations of gelatin, and processing methods, used in confectionery gels. Above 40° C. gelatin in solution behaves like a typical synthetic polymer with the individual macromolecules each assuming random-coil configurations with typical molecular weights of 2×10⁵ Daltons. These random coils consist of single polypeptide chains, termed a-chains that may be entangled. Upon cooling these coils undergo a random coil-to-helix transition, leading to gelation. These solutions may then be cooled to form a gelatin gel. This occurs through a sol-gel transition.

The two important steps in gelatin gelation which are often termed setting and ageing. Setting involves the linking together of irregular regions on the triple helices to form a network throughout the whole gelatin solution. Ageing is the step where gel strength is developed—it appears to go on indefinitely, however the rate of gelation decreases with time at a constant temperature. Ageing involves two mechanisms: first, there is continuous adjustment of the molecular network, through motions of the chains between links; and second, by the dynamic nature of hydrogen bonding. The original interchain links formed in the setting stage are strengthened in this way, as only the strongest bonds of these can survive at constant temperature. These links are extended by incorporating adjacent parts of chains. Occurring simultaneously is the linking together of adjacent collagen-like regions, the network thickens and becomes more fibrillar. The setting process of gelatin is naturally slow and problems of too rapid aggregation are not normally encountered.

The ageing step takes a long period of time, and in confectionery gels, it is believed that interactions between gelatin and other components would slow this process as sucrose and glucose syrup tend to stabilize gelatin structure. Sugars are good at enhancing the stability of conformationally ordered junctions in gelatin gels. The gelation process is connected to conformation transitions of protein chains at <36° C. The triple helix structure of the collagen can be partially recovered, but can depend on local thermal history.

It has been suggested that the most suitable technique to investigate the sol-gel transition of gelatin is rheological analysis, particularly small angle oscillatory measurements, as viscosity and elasticity can be measured without disturbing the gelation process if carried out carefully. Some rheological results on gelatin gelation have shown various phases or steps in the gelatin gelation process and displayed that with the growth of G′ (storage or elastic modulus) the gelatin system has become more solid-like.

### Factors Affecting Gelation of Gelatin

Many of the factors affecting starch gelatinization also affect gelatin gelation. With regards to temperature, since gelatin is a thermoreversible gel, gelling temperature, and temperature gradient during cooling from the sol-state and temperature fluctuations during the gelation process all affect product properties. The lower the ageing temperature, the faster the helix content within the gel will increase, but the lower the stability of the helices will be some junction zones, along with formation at new ones.

The presence of water aids gelatin gelation, however the higher the solids (which could be gelatin granules, powder or leaf) content of the gelatin solution precursor, the faster the gelatin gel will form. The initial change in modulus with time tends to become steeper as gelatin concentration increases, and the modulus plateaus sooner with higher concentrations. Shear can also have an effect on gelatin gelation, and some studies have shown that viscosity of the sol-gel can depend on a combination of shear rate and the probability of bonding occurring.

The presence of other ingredients during gelatin gel formation can affect the gelation process as well as final properties of the gel. When mixing gelatin with gelatinized starch, there is the possibility that amylose leaches into the gelatin phase—perhaps forming a composite and affecting crosslink formation in the gelatin gel. Polymer blending laws indicate that if the concentration of leached amylose is significant in a starch-gelatin-composite system, then the strength of the system may be weaker than a pure gelatin gel due to crosslink inhibition in the gelatin phase. Many factors can affect gelatin gel structure and strength, which in turn affects gel stability.

The final gel, after gelation is complete, is a clear, orange-tinged gel with elastic properties. The specific properties of the gel should indicate what use it is good for. One of the measured properties of a gelatin gel is Bloom. Bloom is determined by measuring the mass required to press a 4 mm diameter probe to a depth of 12.5 mm into a 6.666 w/w % gelatin gel at 10° C. It is the weight that mass, expressed in grams, that is the Bloom number. The Bloom number will determine what application the gelatin is used for, and is set by the method used for extraction of gelatin from collagen, and the conditions under which this extraction is carried out.

As with starch, sugars also serve to stabilize the gelatin gel configuration. Sucrose can help with gelatin dissolution, and stabilize the final product. This is because sucrose/glucose syrup blends can establish a continuous liquid phase with gelatin. The presence of sugar co-solutes can increase the strength of gelatin gels up to a peak co-solute concentration, above which the gel weakens due to a lack of water available to maintain gel integrity. When combined with typical confectionery gel ingredients of starch, sucrose, and water, gelatin tends to retain bound water more easily than the other ingredients.

Ionic force and pH can also have an effect on gelatin gel properties, where pH can affect turbidity (transparency) of gelatin, with the transmittance of gelatins dependent on the isoelectric point of the gelatin. The isoelectric point is the pH at which no net migration occurs within the gelatin when placed in an electric field, and it is dependent on the process for forming the gelatin from collagen, as well as collagen source. A low pH can lower viscosity of gelatin solution during processing due to degradation effects. This pH degradation effect is amplified at high temperature and hence food acids are usually the last ingredient to be added to confectionery gel products during manufacture, usually during cooling.

### Pectin

Pectin is found in virtually all land-based plants and is a structural polymer, the intercellular “glue” that helps to reinforce the basic cellulose structure of plant cell walls. Commercial pectin is extracted under mildly acidic conditions from citrus peel or apple pomace (dried pulp) and sometimes from sugar beet residues or sunflower heads. The chemical structure of pectin consists of a linear chain of galacturonic acid units and can have a molecular weight of up to 150,000.

While still in the fruit, there is, on average, one free acid group (COO—) to every three to four methyl esters of galacturonic acid; although, there is no repeating sequence within the polymer chain. This corresponds to a degree of esterification of 70-80%. Esterification can be controlled during the extraction process, so that the degree of esterification of the final pectin product can range from 0-75%. It is the degree of esterification and the arrangement of methyl esters along the pectin molecule that controls how the pectin behaves as a gelling agent or protein-stabilizing agent.

Pectin with a degree of esterification of <50% is termed low ester or low methoxy pectin and does not require either sugar or acid to gel, but does require calcium to aid gel formation. Pectin with a degree of esterification of >50% is termed high ester or high methoxy pectin, and requires the presence of sugar and acid to set to a firm gel. Grade strength of this type of pectin is determined by the ratio of sucrose:pectin required to form a gel of a particular strength. It is the high methoxy form of pectin that is widely used in the manufacture of jam and gel confectionery.

Commercial pectin used in food production often has sugar added to standardize viscosity and to prevent clumping when the pectin is added to water. Gel formation is carried out by addition of the pectin, with added sugar, in a thin stream to well-agitated water. As pectin absorbs water, the mixture thickens and gelation depends on acidification to the correct level of pH, as well as on the concentration of dissolved sugar. Gelation of pectin occurs very rapidly, so pectin gel confectionery is able to be produced in a continuous manner. Recent advances in the study of pectin have uncovered a wide range of physical pectin structures that may be used for a variety of applications, including confectionery.

### Other Confectionery Gelling Agents

Recently there has been growing interest in the use of bacterial polysaccharides for gel formation as procedures for forming these polysaccharides on a larger scale are developed. Gellan and curdlan are examples of such materials and they have been proposed as useful gelling agents in confectionery. Gellan is a linear, anionic heteropolysaccharide, with a molecular weigh of approximately 5×10⁵ Da. The structure contains tetrasaccharide repeat units consisting of 1,3-β-D-glucose, 1,4-β-D-glucuronic acid, 1,4-β-D-glucose and 1,4,-α-L-rhamnose, along with acyl groups on the 3-linked glucose. If left acylated, gellan forms soft, elastic, transparent and flexible gels but once de-acylated it forms hard, non-elastic brittle gels. Gels formed from gellan are usually very stable over a wide pH range, while an increase in sugar or ion concentration can greatly increase gellan gel strength.

Curdlan is a moderate molecular weight unbranched linear 1,3-β-D glucan with a molecular weight of approximately 100,000 with no side-chains. An advantage of using curdlan as a gelling agent is that gels of differing strength are formed depending on the heating temperature, time of heat-treatment and curdlan concentration. It is commonly used in Japan to improve texture of tofu, bean jelly and fish paste and may have other applications in confectionery jelly.

### Food Acids

Food acids are added to confectionery gels primarily to give a tart tangy taste, and in the case of pectin, to aid gel formation. The choice of food acid is related to the desirable level of sharpness and the likely effect of the acid on rather raw materials present. Common organic food acids used are citric acid, malic acid, tartaric acid, adipic acid and fumaric acid. Lactic acid may also be used, particularly when gelatin is added to fermented milk. The most commonly used acid is citric acid as it causes the least degradation in other food materials used in food products, and it is the food acid being utilized in the gels being studied. The other acids are used in foods to achieve a different flavour profile to citric acid.

Citric acid occurs naturally in lemon juice. It is produced by fermentation through the action of certain moulds on sugar syrups. It is commercially available in anhydrous form and as a monohydrate, is odourless and colourless and dissolves readily in water. In confectionery manufacture, a 50% citric acid solution is commonly added near the end of confectionery gel processing to avoid the harsh combination of acid and high temperature affecting the other ingredients. All fruit acids have the ability to break down sucrose to invert sugar, which is a mixture of dextrose (glucose) and laevulose (fructose). Food acids also lower viscosity in gelatin, as well as cause coacervation of gelatin in mixed gels. The food acids alter the pH of the confectionery gels, and this acidity has some preservative action which helps shelf stability of the gels.

### Colourings

Colourings make CGs more attractive to the consumer. There are three main categories of food colourings.
Synthetic—no similar natural colour.
Nature identical—synthetic material but identical to a natural colour.
Natural—obtained from plants or animals.

It is assumed that colourings have little effect on the mouthfeel/texture of the gels, only affecting appearance properties and perhaps flavour perception. Most colourings are water soluble and are added in very small amounts <1%) during confectionery gel processing. The choice of colour depends on many factors, which can include the effect of highly acid conditions on colour stability, and the presence of protein and various other ingredients which can affect colour intensity.

### Flavourings

Chemically, flavourings are very complex substances, and like colourings they are divided into the three main groups of synthetic, nature-identical, and natural. Flavourings can be essential oils obtained from basic fruit or spice, or a wholly synthetic mixture produced by blending approved chemical materials. Flavouring agents are added at the last moment of production, as they are volatile and can be affected by high temperature. Flavourings must be dosed into the product accurately and blended well to ensure even flavour dispersion. The flavour compounds can be intense, and so are diluted before incorporating into the food product. Natural flavour compounds are more volatile, less stable, than synthetic flavour compounds, but are perceived as better, healthier, and safer.

### Confectionery Gel Forming Processes

Currently most CG products are prepared in the food industry via a multi-step batch process. This process consists of several mixing and heating stages, and a prolonged drying period. Confectionery gels processes serve to gelatinize the starch in the product and blend the sugars, starch gel and gelatin gel together. The ‘cooking’ step can be attained through a range of manufacturing methods using different apparatus.

### Batch Processes

If starch is being used as a gelling agent, this step is often used to form the starch gel, as well as dissolving and concentrating the sugar ingredients. Common cooking methods used in industry include jet cooking, coiled heater cooking, and the more traditional, and now less common, open-pan boiling. Jet cooking involves the injection of high temperature steam at pressure to cook the confectionery gel ingredients. The mix of ungelatinized starch suspended in the sugar solution is often preheated to 70-80° C., prior to being fed into the jet cooker. The jet cooker is often a small vessel, in the order of litres, with a short residence time. Alteration of pump rates and steam valve back pressures can alter the amount of starch gelatinized, and hence, the degree of cooking. This process can be very efficient as both sensible heat and latent heat of the steam can be used to cook the gel ingredients. The main disadvantage is that the steam becomes an ingredient and so care must be taken with boiler water, so it can be of sufficient food grade.

These processes can stand alone as continuous processes, but because of the presence of the stoving step and limited resources (ovens) and time associated with this step, the overall process must be carried out in batches. For the Australian confectionery gels mentioned here, there is a “blending” step prior to the ‘depositing’ step, whereby a gelatin solution is mixed with the cooked carbohydrate ingredients, which can be done via large mixing tanks or complex inline mixing apparatus. Additives are also added prior to depositing.

Depositing often involves moulding of the cooked gel into starch moulds. The stoving step is necessary to reduce the moisture content of the final gel products down to an acceptable level, whereby microbial activity will not occur. Stoving may involve drying at room temperature for 4-6 days, or oven drying for 2-3 days. This step within the process is time and resource-intensive, with high wastage, and there is a need for reducing the time taken to carry this out. The rate of stoving is determined by: size of the jelly product; viscosity of the deposited gel; degradation temperature; and moisture diffusion limitations. Moisture content of the moulding starch will also have an effect, as the moisture gradient between the gel and the starch will determine diffusion rate, as well as moisture diffusivities in these materials.

### Continuous Processes

A trend in recent times has been to develop continuous processes for making food products. Gel confectionery can be formed using a scraped-surface heat exchanger, however, in recent times research into confectionery gel formation has turned to some of the more traditional synthetic polymer processing techniques for inspiration. Two of these techniques are injection moulding and extrusion processing.

### Injection Moulding of Confectionery Gels

Injection moulding involves a similar setup to the extrusion process, but with the use of a die capable of being closed and pressurized to form shapes, rather than a continuous extrudate. It has been studied as a viable process for moulding 85% solids gelatin fruit gums containing 40-60% gelatin. In the study, the parameters of die cylinder temperature, mould time, and plunger dwell time were optimized to give suitable gum products. The main difficulty in the process seemed to be the slow gelling of gelatin, and its low susceptibility to frozen in stress. The gums had strong relaxation on demoulding, indicating that processing parameters had a lesser effect on product properties and all the products formed under different circumstances had similar characteristics. Current processing methods require controlled time and energy. For injection moulded gums, one minute in the mould seemed appropriate to give the requisite gum textural characteristics. However, this amount of time would also be a hindrance unless several hundred products could be moulded with each die cycle. For this reason, extrusion processing may be a better option as a continuous process for confectionery gels containing gelatin. The product continuously emerges in extrusion processing, and there is no waiting for process cycle times.

The rational development of food extrusion processing is dependent on understanding the relationship between microstructural changes of the cooking material, equipment design, and processing conditions. Knowledge of melt rheological characteristics is a prerequisite to performing design calculations on extruder screws and dies and modeling the overall extrusion process. Parameters such as barrel temperature, screw speed, water content and feed rate can be optimized to obtain the required product.

In extruders, starch material is modified all along the screw shown by an intrinsic viscosity decrease, and increase in degree of gelatinization. In single screw extrusion this happens progressively, but in twin screw extrusion there is a characteristic very short melting zone, powder is compacted and dissolved, from which a polymer+melt mix is evolved, then a homogenous molten phase is obtained in a very short time (3-10 s) at high shear rate (approximately 100/s).

### Significance of Glass Transition

Glass transition of an amorphous polymer system is the change in system behaviour from rubbery to hard and relatively brittle. In recent times the importance of this transition has gained wider appreciation of its use in understanding and quality control of such systems. Confectionery gels are amorphous polymer systems and hence the rubber to glass transition is a significant factor in analysis of the gels. A common method to find when glass transition occurs is to determine glass transition temperature (Tg), but other techniques such as dynamic mechanical analysis may be used to observe where the changes in behaviour from rubber to glass occur.

### Structure-Property Relationships in Food Gels

In an attempt to investigate how properties of food gels are developed, a few recent studies have looked at the relationships between microstructure and properties of food gel type systems. Many studies have begun to look at composite gels and related properties, while taking into account the effects of microstructural characteristics on these properties. Composite gels often consist of protein and polysaccharide components, and hence have a tendency to phase separate. The studies state some reasons why the molecular arrangement of the composite gel systems affects such properties. New techniques have even looked at combining microstructural analysis with rheological analysis, in one machine measurement, whilst models are now being developed to predict biopolymer gel properties based on their structural characteristics.

The focus in the past has been on the effects of additives or processing changes on individual gel characteristics, without considering the relationships of gel characteristics to each other. Very few studies have looked at complete confectionery gel systems, containing carbohydrate, protein and high sugar co-solutes, and the relationships between gel properties and structure. Some studies have been carried out looking at gel composites with co-solutes of sucrose and glucose syrup, as these systems are representative of true food gel products.

The present invention fills a long felt need in gummies containing a fill that includes nutraceuticals, pharmaceuticals, dietary supplements and ingredients that provide beneficial effects.

### SUMMARY OF THE INVENTION

The invention provides an edible, digestible composition that includes a chewable composition including a center-fill composition comprising a flavored liquid ingredient, and a chewable shell surrounding the center-fill composition, the chewable shell comprising a binding agent, flavoring ingredient, and a sweetener, and at least one health promoting ingredient. By ingesting the gummy candy, the consumer is able to directly supply his or her body with active health ingredients

The compositions of the invention may be in the form of a gummy candy that includes a binding agent, sweetener, flavoring and coloring, and a polishing agent. For example the gummy candy may include gelling substance such as gelatin or pectin or carrageenan or mixtures thereof, sucrose, a sweetening syrup, citric acid, lactic acid, natural flavors, fractionated coconut oil, and carnauba wax.

The invention further provides a chewable composition which may include a confection selected from the group consisting of: hard candy, fudge, toffee, taffy, liquorice, chocolates, marshmallows and a combinations thereof.

The invention provides a chewable composition comprising: a center-fill composition comprising a flavored liquid ingredient and at least one health promoting ingredient; and a chewable shell surrounding the center-fill composition, the chewable shell comprising a binding agent, flavoring ingredient, and a sweetener.

The invention is also directed to a method of forming a chewable supplement which method includes the steps of preparing a premix compound and blending a portion of the premix compound with at least one health promoting ingredient and a sweetener to form a blended slurry. After this, the blended slurry is cooked to form a cooked candy. Food acid, flavor and color are then added to the blended slurry. Next, the blended slurry is deposited onto a mold to form a shell and a flavored liquid is then deposited into the shell, where the shell and flavored liquid form a liquid-filled composition. After this step, the liquid-filled composition is cured to form a chewable supplement.

The invention further provides a method of forming a chewable supplement, comprising: preparing a premix compound; blending a portion of the premix compound with at least one health promoting ingredient and a sweetener to form a blended slurry; cooking the blended slurry to form a cooked candy; adding food acid, flavor and color to the blended slurry; depositing the blended slurry onto a mold to form a shell; depositing a flavored liquid into the shell, the shell and flavored liquid forming a liquid filled composition; and curing the liquid filled composition to form a chewable supplement.

Additional devices, apparatus, systems, methods, features and advantages of the invention will be or will become apparent to one with skill in the art upon examination of the figures and detailed description. It is intended that all such additional systems, methods, features and advantages be included within this description, be within the scope of the invention, and be protected by the accompanying claims.

### BRIEF DESCRIPTION OF THE FIGURES

FIG. 1 shows the process flow diagram for the manufacturing of honey filled gums.

FIG. 2 illustates process flow diagram for the manufacturing process of honey filling for gums.

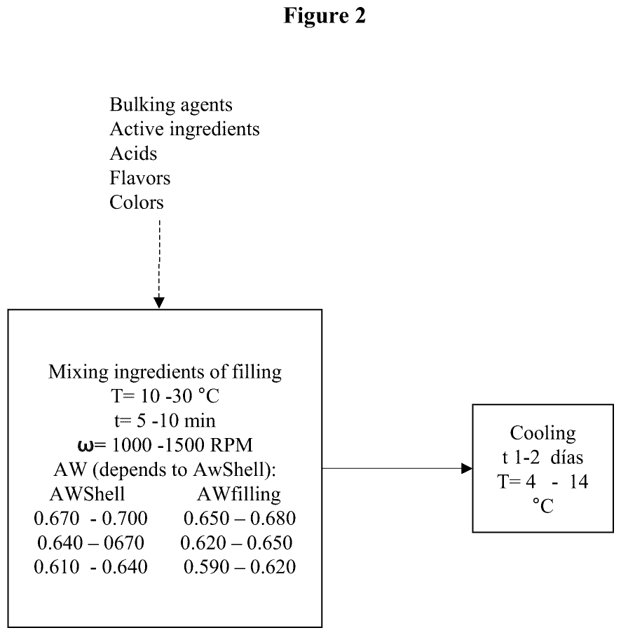

### DETAILED DESCRIPTION OF THE INVENTION

The present invention relates to a liquid-filled chewable delivery system designed to enhance the delivery of dietary supplements and pharmaceutical compounds. The chewable delivery system may include a primary active ingredient (e.g., dietary supplement or pharmaceuticals) to provide the desired effect, and a delivery vehicle (i.e., the gummy candy) to contain and deliver the active ingredient to the consumer by oral ingestion.

The primary active ingredient of the present invention may include a health supplement or bioactive compound. More specifically, the active ingredient may include any combination of dietary supplements or pharmaceuticals, in liquid extract or powder form. For example, in one implementation, the active ingredient may include any combination of vitamins, nutraceuticals, minerals, antioxidants, soluble and insoluble fiber, herbs, plants, amino acids, prebiotics, probiotics, fatty acids, digestive enzymes, nutraceuticals, or any other health promoting ingredient. In another implementation, the active ingredient may include all drugs listed in the Physicians Desk Reference (incorporated by reference in its entirety) (both prescription and over the counter drugs) to treat symptoms of all known illnesses. Any combination of dietary supplements with pharmaceutical compounds will be dependent in part on their compatibility with the pharmaceutical compound.

As used herein, a “pharmaceutical compound” or “drug” shall include, but is not limited to, any drug, hormone, peptide, nucleotide, protein, antibody, or other chemical or biological substances used in the treatment or prevention of disease or illness, or substances which affect the structure or function of the body.

As used herein, an “over-the-counter drug” or “OTC” refers to a pharmaceutical compound, drug, or medication that may be sold directly to a consumer without a prescription from a healthcare professional.

As used herein, a “prescription drug” refers to a pharmaceutical compound, drug, or medication that may be sold only to consumers possessing a valid prescription from a healthcare professional.

As for the dosage, the active ingredients of the present invention are generally expressed in terms of grams or milligrams, but may also be expressed in active units, or international units (IU). In some implementations, the dosages of health supplements and/or pharmaceutical compounds in each gummy candy may be relatively low, allowing the consumer to adjust his/her intake of health supplements based on nutritional guidelines applicable to the particular individual.

The primary active ingredient may be delivered in a delivery vehicle that is palatable and easy to swallow. In one implementation, the delivery vehicle is chewy or gummy-like to facilitate swallowing. The delivery vehicle may include a sweetener(s), a stabilizer(s) or binder(s), a humectant(s), and/or natural and/or artificial flavors. The delivery vehicle may include natural and/or artificial colors and preservatives. In one implementation, the delivery vehicle may include a sweetener syrup, natural cane juice, gelatin, citric acid, lactic acid, natural colors, natural flavors, fractionated coconut oil, and carnauba wax.

The invention provides a chewable composition comprising: a fill composition comprising a flavoring ingredient; and a chewable shell surrounding the center-fill composition, the chewable shell comprising a binding agent, flavoring ingredient, a sweetener, and at least one health promoting ingredient.

There is also provided a chewable composition comprising: a fill composition comprising a flavored liquid ingredient and at least one health promoting ingredient; and a chewable shell surrounding the center-fill composition, the chewable shell comprising an organic binding agent, a flavoring ingredient, and an organic sweetener.

The shell of the invention which is typically 85% by weight of the gummy is made from 30-50% by weight of organic sweetener syrup, 25-50% by weight of organic sugar, 17-20% by weight of paste cook water, 0.1-20% by weight active ingredients, 0.3-0.6% by weight sodium citrate, 1-3% by weight pectin, 0.1-2% by weight flavors, 0.1-2% by weight natural colors, and 1-3% by weight of citric acid/lactic acid/malic acid.

The filling which is typically 15% by weight of the gummy is made from 0.1-11% by weight of sweeteners, 0.1-2% by weight hydrocolloids, 0.1-2% by weight flavors, 0.1-2% by weight natural colors, 0.1-2% by weight citric acid/lactic acid/malic acid and mixing water d.o.i.

The invention also provides a method for producing a filled gummy, said filled gummy comprising a gelified shell and a filling encased inside said gelified shell; wherein the filling comprises at least one active ingredient; the method comprising the steps of: (1) preparing a gelified shell composition by: (i) dissolving a first gelifiable product in water to form a first gelified solution; (ii) optionally adding at least one first sweetener and optionally one or more secondary ingredients to the first gelified solution; (2) preparing a filling composition, wherein the filling composition comprises at least one bulking agent and one or more active ingredients dissolved or suspended in said filling composition; (3) depositing the gelified shell composition and the filling composition thereby fully encasing the filling composition with the gelified shell composition; (4) setting the deposited gelified shell composition; wherein the temperature of the shell is 80-99° C., the temperature of the filling composition upon deposition is 4-20° C., and wherein the viscosity of the shell is 6000-8000 Cp and the viscosity of the filling composition upon deposition ranges between 50000-120000 Cp.

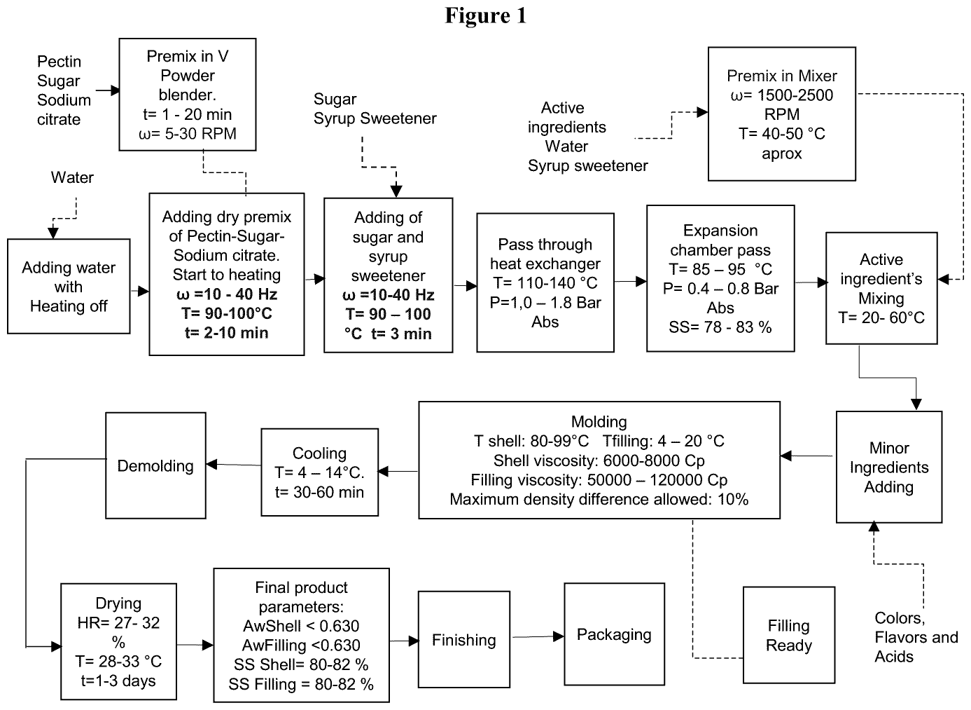

Referring now to FIG. 1, there is shown an example of a process for manufacturing a gummy delivery system of the present invention. In capsule summary, the method of manufacturing involves three main phases: (i) pre-mixing (i.e., compounding) and storing; (ii) batching and cooking; and (iii) depositing and curing.

In the first phase of pre-mixing and storing, the first step includes preparing a premix compound. The premix compound may be prepared by combining water with a binding agent or gelling compound (e.g., gelatin, pectin, starch, carrageenan and/or gum) in a mixing tank, for example. The mixing tank may be any one of a plurality of different sizes. In some implementations the mixing tank may include a 1,000 gallon stainless steel planetary mixer, a scrape surface mixer, a holding tank with an agitator, or any other food-grade mixing apparatus. Although not required, in some implementations, the gelling compound may be mixed with warm water (e.g., water at an initial temperature of about 180° F.) in the mixing tank to facilitate hydration of the gelling compound; i.e., to facilitate efficient mixing of the water and the gelling compound.

During production, water and the gelling compound may be continuously mixed. For example, an agitator may be included in the mixing tank to keep the gelling compound from settling on the bottom of the tank. In some implementations, approximately 6,000 lbs to 8,000 lbs of premix compound may be produced in a period of about eight hours. In general, the gelling compound will be mixed with the water until a substantially homogeneous premix compound is formed; i.e., until the premix compound has a substantially uniform composition throughout the mixture.

As stated above, the gelling compound or binding agent may include gelatin, pectin, food starch, carrageenan, gum, or any other suitable binder, or combination thereof. For example, the binding agent may include gelatin products produced from animal sources such as beef or pork, or any other suitable gelatin product.

Examples of gelling compounds including pectin products may include high (methyl) ester or low (methyl) ester pectin products made from fruit sources, such as apples, apricots, carrots, citrus fruits, or any other suitable pectin product.

Examples of gelling compounds including starch ingredients may include corn starch, rice starch, potato starch, starch derivatives, and the like.

Examples of gelling compounds including carrageenan ingredients may include kappa (κ) carrageenans, or lambda (λ) carrageenans.

Depending on the binding agent used, the premix compound may include, as a non-limiting example, any one of the following formulations illustrated in Tables 1 and 2:

TABLE 1
FORMULA BASE FILLED GUMMIES

| RAW MATERIAL (RM) | PERCENTAGE (%) |
|---|---|
| SHELL | 85% |
| Organic Sweetener Syrup | 30-50% |
| Organic Sugar | 25-50% |
| Paste Cook Water | 17-20% |
| Actives Ingredients | 0.1-20% |
| Sodium Citrate | 0.3-0.6% |
| Pectin | 1-3% |
| Flavors | 0.1-2% |
| Natural Colors | 0.1-2% |
| Citric Acid/Lactic Acid/Malic Acid | 1-3% |
| FILLING | 15% |
| Sweeteners | 0.1-11% |
| Hydrocolloids | 0.1-2% |
| Flavors | 0.1-2% |
| Natural Colors | 0.1-2% |
| Citric Acid/Lactic Acid/Malic Acid | 0.1-2% |
| Mixing Water | D.O.I |

In the above table all percentages are by weight.

TABLE 2
FORMULA BASE FILLED GUMMIES

| RAW MATERIAL (RM) | PERCENTAGE (%) |
|---|---|
| SHELL | 85% |
| Organic Tapioca Syrup | 30-50% |
| Organic Sugar | 15-50% |
| Paste Cook Water | 12-20% |
| Actives Ingredients | 0.1-20% |
| Sodium Citrate | 0.3-0.6% |
| Pectin | 1-3% |
| Flavors | 0.1-2% |
| Natural Colors | 0.01-2% |
| Citric Acid/Lactic Acid/Malic Acid | 1-3% |
| FILLING | 15% |
| Sweeteners | 0.1-11% |
| Active Ingredients | 0.01-3% |
| Hydrocolloids | 0.01-2% |
| Flavors | 0.1-2% |
| Natural Colors | 0.1-2% |
| Citric Acid/Lactic Acid/Malic Acid | 0.1-2% |
| Moisturizers | 0.1-2% |
| Mixing Water | D.O.I |

In the above table all percentages are by weight.

The moisturizers are selected from the group consisting of: Glycerin, Sorbitol, polyethylene glycol, propylene glycol. The sweeteners are selected from the group consisiting of: sugar, dextrose, glucose syrup, tapioca syrup, polyalcohols such as sorbitol, maltitol, xylitol, mannitol, dietary fibers such as chicory and agave inulin, polydextrose, Oligosaccharides such as fructo-Oligosaccharides (FOS), Isomaltooligosaccharide (IMO), Xylo-Oligosaccharides (XOS), and sweetness enhancers such as Stevia and Monk fruit.

The invention provides a new gummies consumption experience wherein such gummies include two phases (Filling and Coatings). The invention allows for better incorporation of the actives, providing them with greater stability in the product. The invention prevents cross contamination in the production process. Furthermore, prevents degradation of actives in the final product during the defined or desired useful life. The invention also allows for control of the place of dissolution and/or the dissolution profile of the active according to its function. The invention also allows for a reduction in the amount of excess actives. Also, it provides options of two gummy products of animal and vegetable origin.

The invention further provides a filled gummy that is stable over time and that in its complete formulation can provide the consumer with the benefits of different active ingredients, which currently cannot be obtained with a single-phase gummy due to the risk of cross contamination, due to the manufacturing process or due to the nature and solubility of the active ingredients and the gummy matrix, or difficulties that arise with different active ingredients in the process and product.

The prior art shows the development of a gelatin capsule that releases medication in a controlled manner. The main advantage of our gummy with filling, which works as a food and/or dietary supplement given that it contains different active ingredients, compared to the capsule with its active components is that it achieves an only product that contains two or more active ingredients in different phases. The following advantages are that they are different forms of presentation of the product, filled gummies since they are chewable have the possibility of acquiring different shapes, colors and flavors, making them more attractive to consumers of all ages, additionally the filling in The gum provides a difference in textures during chewing and this makes the tasting experience more fun and indulgent.

The invention provides in a single gummy active ingredients that initially could not be mixed in a single gummy matrix or phase due to their nature, the manufacturing process or to avoid cross-contamination with the active ingredients that are desired to be included in a single product. This inventive development can have different textures in gummy fillings such as hard Gel/“Jelly” and/or extruded type fillings.

In some embodiments, a buffer may be added to the mixing tank during preparation of the premix compound in order to regulate the pH of the premix compound. A food grade acid may be used as the buffer, such as citric acid, lactic acid, fumaric acid and/or malic acid. Other buffers include solutions of hydroxides, carbonates, citrates, phosphates, and mixtures thereof and salts thereof, e.g., sodium bisulfate and sodium citrate. As a non-limiting example, the premix compound may include approximately 0.005 to 0.04% by weight of a buffer solution, or any other suitable amount for maintaining the pH of the premix compound within a range of from about 3.2 to about 4.0 during mixing.

Once the premix compound is prepared, it may then be filtered through a basket strainer (e.g., a 0.034 inch stainless steel basket strainer) or fine mesh filter material and stored in a holding tank. The holding tank may be various sizes. In one embodiment, the holding tank may be a 1,500 gallon stainless steel tank. In some embodiments, the holding tank may include a moderate agitator (e.g., mixing blades) for keeping the gelling compound in the premix compound from settling out of the mixture and to the bottom of the holding tank.

In the second phase of batching and cooking, a predetermined amount of the premix compound may be delivered from the holding tank to a mixing vessel where the premix compound may be mixed and blended with various substances, including sweeteners and the primary active ingredient, i.e., nutritional supplements and/or pharmaceuticals, to form a slurry. The manner in which nutritional supplements and/or pharmaceuticals are incorporated into the gummy delivery system may depend on the heat sensitivity of the particular active ingredient. As further discussed in detail below, certain ingredients that are heat resistant may be added in solid form to the mixing vessel. As a non-limiting example, 250 lbs to 370 lbs of premix compound may be delivered to the mixing vessel every 5 to 10 minutes. In some embodiments, the mixing vessel may be similar or identical in configuration to the mixing tank described above.

In the mixing vessel, water, sweeteners, heat resistant prebiotics and/or probiotics, and additional supplements, if any, may be added to the premix compound to form a slurry mixture, for example. In one embodiment, a sweetening syrup mix along with solid prebiotic may be added to the premix compound and may be dissolved in the premix compound to form a slurry mixture. In one embodiment, the sweetening syrup mix may include bulk sugar (that has been filtered and irradiated), water, corn starch, sodium citrate, sweetening syrup, and white grape puree. In embodiments in which the active ingredient is added, the amount of active ingredient added to the premix may vary depending upon the type of chewable composition (e.g., organic or non-organic) and the desired dosage to be delivered to the consumer in the resulting chewable supplement.

Various sugars may be used as sweeteners for the gummy candy and may be added to the premix compound. Examples of appropriate sweeteners include, but are not limited to: sucrose (derived from beets or sugar cane, for example); fructose; sweetening syrups (which may help prevent other sugars from crystallizing in the gummy candy and may help add body to the candy, maintain moisture levels in the candy, and lower the cost of producing the candy); sorbitol, xylitol and maltitol (which are humectants); and/or various combinations of the foregoing. In one embodiment, the slurry mixture may contain approximately 70% to 85% sweetener by weight, while the remaining approximately 15% to 30% of the slurry (by weight) may contain the premix compound and additives.

Prior to production, the sweeteners may be stored in bulk tanks. In one embodiment, the sweetener may be stored in a holding tank at a temperature of approximately 75° F. For example, in a sweetener holding tank including sweetening syrup, the syrup may be irradiated by ultraviolet light to remove any contaminants in the syrup. The syrup may be any suitable liquid sweetener or combinations thereof. During production, the sweetening syrup may be administered to the mixing vessel manually or by automation.

Similarly, prior to production, sugar in granular form may be stored in a holding tank. During production, sugar may be fed through an automated feed system that filters the sugar to remove sediments, weighs the sugar, and delivers a desired quantity of sugar to the mixing vessel. In other embodiments, sugar may be added to the mixing vessel manually.

In some embodiments, various dietary supplements may by added to the premix compound such as vitamins, minerals, fibers, herbs, plants, amino acids, antioxidants, prebiotics, probiotics, fatty acids, nutraceuticals, enzymes or any other supplements digested to promote the health and well-being of a person. Such supplements may include, but not be limited to, any of the following: Vitamin B1 (Thiamine), Vitamin B2 (Riboflavin), Vitamin B3 (Niacinamide), Vitamin B5 (Pantothenic Acid), Vitamin B6 (Pyridoxine HCl), Vitamin B12, Biotin, Folic Acid, Vitamin C (Ascorbic Acid/Activated C), Calcium, Carotene, Chromium, Copper, Vitamin D (Cholecalciferol), Vitamin E, Ginseng, Iron, Vitamin K (Phytonadione) and St. John's Wort. The above list of dietary supplements is not exhaustive, but is provided for illustrative purposes only.

Once the premix compound is blended with the predetermined amounts of sweetener (and in some embodiments, heat-resistant active ingredients), the resulting slurry may be heated to evaporate excess water, as shown in FIG. 1. In some embodiments, a series of substeps are included. In one embodiment, the slurry from the mixing vessel may be processed through a magnetic device, such as a finger magnet or any other suitable magnetic device, which removes particulates in the slurry. As the slurry is processed through the magnetic device, the slurry may pass through a series of heat exchangers in order to heat the slurry to a predetermined temperature; e.g., 150° F. to 185° F. Since some steps may include heating the slurry to relatively high temperatures, only active ingredients with a high resistance to heat (e.g., active ingredients that may withstand temperatures in excess of 200° F. without breakdown of their molecular structure) should be added (e.g., in solid form). As the slurry passes through the series of heat exchangers, the slurry may be received by a storage buffer tank, such as a 5,000 gallon stainless steel industrial holding tank, for example. In some embodiments, the storage buffer tank may include a moderate agitator to keep any active ingredients from settling to the bottom of the storage buffer tank, for example.

From the storage buffer tank, the warm slurry may flow to a static cooker, where water may be evaporated from the slurry. In some embodiments, evaporated water may be condensed, filtered and recycled for re-processing. In the static cooker, in some embodiments, the slurry may be cooked to a temperature of approximately 220° F. to 260° F. for approximately 30 sec. to 60 sec., until the slurry is gelatinized (i.e., dehydrated). In one embodiment, the static cooker may be a 2,500 gallon high pressure steam jacketed kettle, a vacuum pressure cooker, or any other suitable cooker. In the static cooker, moisture is evaporated out of the candy slurry as the slurry is boiled. After about a minute of boiling, the slurry may consist of about a 65 to 75 brix solution.

As used herein, the term “brix” refers to the dissolved sugar-to-water ratio of a liquid or gel. For example, as described above, after boiling, in some embodiments, the slurry mixture may include a ratio of dissolved sugar-to water of about 65:35 to about 75:25, on a weight/weight basis.

After the candy slurry is cooked, the cooked candy may be subjected to a vacuum. In one embodiment, the static cooker may include a vacuum apparatus. In another embodiment, the cooked candy may be delivered to an industrial vacuum chamber or any other suitable enclosure including a vacuum apparatus. In the vacuum, moisture is drawn from the cooked candy by suction pressure. In some embodiments, a vacuum of approximately 40 psi to 50 psi may be applied to the candy stock for approximately 15 sec. to 30 sec. However, the pressure of the vacuum and the vacuum rate will vary according to the capabilities and size of the vacuum apparatus. At this juncture, in some embodiments, the cooked candy may have a brix of approximately 67 to 80, and a pH of approximately 2.8 to 4.0, for example. The cooked candy may then be filtered through a strainer.

Once cooked and filtered, the cooked candy may be transferred to a food acid tank and mixed with food acid to help control the pH of the cooked candy. Examples of food acids include: citric acid, lactic acid, fumaric acid, malic acid, ascorbic acid and the like. After adding the food acid(s), moderately heat sensitive ingredients may be added to the cooked candy, such as various flavorings and color additives, as well as moderately heat sensitive ingredients. For example, probiotics, prebiotics, or heat sensitive drugs may also be added to the cooked candy in solid form. To help protect moderately heat sensitive active ingredients, for example drugs, the active ingredients may be encapsulated. Encapsulated active ingredients may be added in some embodiments. Encapsulation involves formulating a soft gel cap to cover the active ingredient, where the soft gel cap has heat resistant properties. In some embodiments, the soft gel cap is a one-piece, hermetically sealed soft gelatin shell containing a liquid or semisolid called a fill. The soft gel shell may include a film-forming material such as gelatin, and a water-dispersible or water-soluble plasticizer (to impart flexibility). The soft gel shell may also include minor additives such as coloring agents, flavors, sweeteners and preservatives.

In some embodiments, the cooked candy may be passed through a trough-like apparatus known as a dosier. In the dosier, water, flavoring, coloring, and food grade acid may be added to the cooked candy to enhance the candy's taste and appearance. For example, flavoring such as artificial flavoring (i.e., mixtures of aromatic chemicals, including, but not limited to methyl anthranilate and ethyl caproate) and/or natural flavoring (i.e., flavoring obtained from fruits, berries, honey, molasses, maple sugar and the like) may be added to the cooked candy to give the candy a desired flavor. To balance the flavor (in addition to regulating the pH of the cooked candy), food grade acid may be added to the cooked candy. Such food acids may include citric acid, malic acid, lactic acid, adipic acid, fumaric acid, tartaric acid, or any other suitable food grade acid, or combination thereof. In one embodiment, the flavoring, coloring, and acid may be continuously added to (e.g., dripped on) the cooked candy as the candy moves through the dosier to a starch depositor. Color additives in various combinations may be added to the cooked candy to achieve the desired color, including: red dye #40; yellow dye #5; yellow dye #6; blue dye #1, and combinations thereof. Color additives may also include natural coloring such as black carrot, annatto, tumeric, and purple berry concentrate.

The amount of flavoring, coloring, and acid added to the cooked candy may vary according to the volume of cooked candy passing through the dosier, for example, and the desired candy formulation. Approximately 1% to 2% flavoring by weight and approximately 0.01% to 0.03% acid by weight may be added to the cooked candy composition. However, the amount of acid and flavoring added to the cooked candy formulation must be balanced to ensure the desired taste. Thus, depending on the formulation, more flavoring and less acid may be added to the cooked candy for bitter formulations, for example. For instance, to mask the flavor of a particular active ingredient in the cooked candy, a flavoring agent such as strawberry flavor or cherry flavor may be added to the mixture. The additional flavor may be adjusted based upon the active ingredient's dosage. In some instances, only food acid may be added to the cooked candy.

In other embodiments, titanium dioxide may be added to the cooked candy to provide sheen. Those of skill in the art will recognize that various shine-enhancing agents may be utilized in conjunction with the present invention. Titanium dioxide may also stabilize the cooked candy formulation so the coloring does not bleed when it is handled, packaged, or stored.

Prior to the depositing and curing phase, the cooked candy may be subjected to quality control; i.e., the cooked candy may be checked for proper brix, pH, temperature, and proper organoleptic effects, among other characteristics.

After the above steps, the candy is ready for the depositing and curing phase, and may be transferred to a starch depositor or molding machine subsequently. In one embodiment, the starch molding machine may include any commercially available starch depositing equipment (simply referred to as a “Mogul”). Thus, the cooked candy may be deposited onto a starch-coated mold to allow the cooked candy to become firm and to take on the shape of the mold.

A Mogul is a starch molding machine that automatically performs the multiple tasks involved in making gummy candy. Gummy candy may be produced in the Mogul batch-wise or via a continuous process. To start the process, the cooked candy, or gummy stock, is deposited by depositors (e.g., filling nozzles) onto starch lined trays (“mogul boards”). The mogul boards allow the cooked candy to firm and take on the shape of the tray mold, to produce a series of shaped gummy candies. In one embodiment, the depositors are timed to automatically deliver the exact amount of candy needed to fill the trays as the mogul boards are passed under the depositors. In some embodiments, the coloring, flavoring, and acids added to the cooked gummy candy may be added to the candy in the depositor.

A Mogul is called a starch depositor because starch is a main component of the machine In this machine, starch has three primary purposes. First, it prevents the gummy candy stock from sticking to the mogul boards, which allows for easy removal and handling. Second, starch holds the gummy candy in place during the drying, cooling, and setting processes. Finally, starch absorbs moisture from the candies, giving them the proper texture.

In some cases, the starch used to coat the mogul boards may include recycled starch; i.e., wet starch that falls away from the candies when they are removed from the mogul boards. The re-used starch may be recycled to a starch dryer where the starch is sifted and dried. After the starch is dried, it may then be cooled in a starch cooler. The cooled starch may be sifted a second time and returned to the Mogul where it may be re-circulated once again, through the same process. The recycled starch may then be sprayed evenly on the mogul board, where the cooked candy may then be deposited onto mogul boards coated with the recycled starch.

In alternate embodiments of the present invention, a liquid-fill may be added to the cooked candy to form a center-fill composition or slurry. The liquid-fill may include, but not be limited to, fruit juice, vegetable juice, fruit puree, fruit pulp, vegetable pulp, vegetable puree, fruit sauce, vegetable sauce, honey, sweetening syrups, polyol syrup, hydrogenated starch hydrolysates syrup, emulsions, vegetable oil, glycerin, propylene glycol, ethanol, liqueurs, sorbitol or any other liquid sweetener, dairy-based liquids such as milk or cream, or any combination thereof.

In additional embodiments, the center-fill slurry may be incorporated into the center of the cooked candy through a dual-step depositing process. For example, during the first depositing step, an outer mold or candy shell consisting of the cooked candy may be deposited onto the mogul boards. Following the first depositing step, the candy may be processed through a second depositing step, where the center-fill slurry may be deposited into the center of the shell.

In further embodiments, to ensure that the center-fill slurry is suspended in the center of the candy shell (i.e., does not rise or sink into the shell), the temperature and specific gravity of the center-fill slurry may be less than that of the cooked candy. For example, in one embodiment, the temperature of the center-fill deposited, may be, for example, 15° F.-30° F. less than the temperature of the deposited cooked candy, and the specific gravity of the center-fill slurry may be, for example, 5%-15% less than the center of gravity of cooked candy.

In another embodiment, the center-fill slurry may comprise, for example, about 10% to 30% of the total weight of chewable composition, depending on the differences in the specific gravities of the cooked candy shell and the center fill-slurry. By way of example only, if the total weight of the chewable composition is 5 g, the weight of the cooked candy shell portion may be 3 g and the weight of the center fill may be 2 g.

In other embodiments, the center-fill slurry may be incorporated into the center of the cooked candy by a single dual deposit process. In this instance, the center-fill may be incorporated into the cooked candy by a dual nozzle depositor that simultaneously deposits the cooked candy and the center-fill. Here, the active ingredients may be added to the center-fill, the cooked candy, or both. According to this embodiment, the specific gravity of the center-fill may be less than the specific gravity of the cooked candy.

In alternate embodiments, active ingredient may be blended with the liquid fill to form the center-fill slurry. In such embodiments, the center-fill slurry may consist of about 25% by weight to about 40% by weight active ingredient, depending on the type (i.e., dietary supplement or pharmaceutical) and form of active ingredient used (i.e., liquid or powder). The active ingredient may include a pharmaceutical and/or any combination of vitamins, minerals, antioxidants, soluble and insoluble fiber, herbs, plants, amino acids, and digestive enzymes, or any other health promoting ingredient. In embodiments where the active ingredients are heat sensitive, the active ingredients may be encapsulated within the center-fill slurry. The amount of active ingredient added to center-fill slurry will vary depending upon the type of chewable composition (e.g., organic or non-organic) and the desired dosage to be delivered to the consumer in the resulting chewable supplement. In some embodiments the active ingredients may be encapsulated to manage or delay the release of the active ingredient into the mouth or throat of the consumer.

After the cooked candy is deposited onto the mogul boards, the mogul boards may be stacked, then removed from the stack (one-by-one) by a conveyor belt, and finally placed in a temperature and humidity controlled curing room, where the candy sits and cools (i.e., is cured), for approximately 24 hours to 48 hours in some embodiments. However, the curing time for the cooked candy may vary based on the particular binding agent used in the candy and the temperature and humidity of the curing room. Proper curing time is necessary to solidify, or set the gummy product to ensure ease of packaging without breakage and proper yield. In some embodiments, the candy may be cured in a curing room with approximately 15% to 25% humidity.

After curing, the gummy candies, firmed and having proper texture, may be moved to a section of the Mogul called the starch buck. In the starch buck, the mogul boards are inverted and the gummy candies are dumped into a tumbler machine. In one embodiment, the tumbler may include a 2,000 gallon rotating drum or, in other embodiments, a vibrating metal sieve. In the tumbler, the gummies may be tumbled together to remove any excess starch that adheres to the gummy candies. In some embodiments, the vibrating metal sieve may include oscillating brushes for removing excess starch adhered to the gummies. In some embodiments, excess starch may be removed by fast-rotating compressed air jets. Once the starch is removed, the gummies may become sticky, so the gummies may be coated with a polishing compound or lubricating agent to prevent the cooked candies from sticking together. Depending on the desired finished product or preferences, the gummies may be polished with fractionated coconut oil, linseed oil, sunflower oil, bees wax, carnauba wax, mineral oil, partially hydrogenated soybean oil, pear concentrate, confectioner's glaze or any other suitable food grade oil or combination thereof. In other embodiments, the gummies may be sanded with sugar or a sugar substitute in a drum.

In embodiments in which the active ingredient (e.g., drugs, probiotic(s) and/or prebiotic(s)) are particularly sensitive to heat, the active ingredient may be incorporated into the gummy delivery system in liquid form (e.g., extract) or frozen form (e.g., frozen yogurt) in a multiple-deposit step prior to curing, or after curing during coating step. In the multiple-deposit step, the gummy stock may be deposited on the mogul boards during a first deposit step. Next, the heat sensitive active ingredient(s) may be added to a syrup (e.g., a sugar and water syrup) that is deposited on the gummy stock during a second deposit step. The gummy stock is then allowed to cure, thus having an active ingredient-containing syrup coating. In alternative embodiments, heat sensitive active ingredients may be added to the solid sugar particles, thus creating a sugar coating that may be applied to the gummy candy during the manufacturing process.

After the gummies are coated, they may be placed on an inspection belt, where the candies are inspected for food safety and proper organoleptic effects. For example, on the inspection belt the gummy candies may be passed by a detector or x-ray to insure that no particulate or other foreign material has been deposited into the candy during the depositing stage. Once the candy passes inspection, it is packaged for distribution.

During packaging and storage, the finished gummy candies may be refrigerated to maintain the shelf-life and efficacy of the active ingredients, for example. Alternatively, the gummy candies may be specially packaged, for example, in a vacuum pack injected with liquid nitrogen.

### EXAMPLES

### Example 1

| RAW MATERIAL (RM) | |
|---|---|
| SHELL | 85% |
| Organic Tapioca Syrup | 30-40% |
| Organic Sugar | 20-40% |
| Paste Cook Water | 15-22% |
| Pectin | 1-3% |
| Citric Acid | 1-3% |
| Vitamin C | 0.1-5% |
| Glazing Agent | 0.1-10% |
| Citrato De Sodio Dihidratado | 0.3-0.6% |
| Sabores | 0.1-2% |
| Zinc Citrate | 0.1-5% |
| Colorantes | 0.01-2% |
| FILLING | 15% |
| Organic Tapioca Syrup | 0.1-6% |
| Organic Sugar | 0.1-5% |
| Usp Glycerin | 0.1-1% |
| Sorbitol 70% | 0.1-1% |
| Acerola Extract | 0.01-3% |
| Citric Acid | 0.01-1% |
| Lactic Acid | 0.01-1% |
| Potato starch | 0.01-2% |
| Colorantes | 0.01-1% |
| Sabores | 0.01-1% |
| Agua | D.O.I |

### Example 2

| RAW MATERIAL (RM) | |
|---|---|
| SHELL | 85% |
| Organic Tapioca Syrup | 30-50% |
| Organic Sugar | 15-50% |
| Paste Cook Water | 12-20% |
| Honey | 0.1-10% |
| Pectin | 1-3% |
| Citric Acid | 1-2% |
| Vitamin C | 0-1-5% |
| Sodium Citrate | 0.3-0.6% |
| Sabores | 0.01-2% |
| Marshmellow Root Extract | 0.1-3% |
| Zinc | 0.1-2% |
| Colorantes | 0.01-2% |
| FILLING | 15% |
| Honey | 1-15% |
| Pregel Starch | 0.01-2% |

### Example 3

| RAW MATERIAL (RM) | |
|---|---|
| SHELL | 85% |
| Organic Tapioca Syrup | 30-50% |
| Organic Sugar | 15-50% |
| Paste Cook Water | 15-25% |
| Dark Honey Blend | 0.1-10% |
| Pectin | 1-3% |
| Citric Acid | 1-3% |
| Vitamin C | 0.1-5% |
| Sodium Citrate | 0.3-0.6% |
| Sabores | 0.1-2% |
| Marshmellow Root Extract | 0.1-2% |
| Zinc | 0.01-1% |
| Melatonin | 0.01-1% |
| FILLING | 15% |
| Honey | 1-15% |
| Pregel Starch | 0.01-2% |

### Example 4

| RAW MATERIAL (RM) | |
|---|---|
| SHELL | 85% |
| Organic Tapioca Syrup | 30-50% |
| Organic Sugar | 15-50% |
| Paste Cook Water | 12-20% |
| Marine Oil 35/25 Tg | 0.1-10% |
| Pectin | 1-3% |
| Citric Acid | 1-3% |
| Sabores | 0.1-2% |
| Sodium Citrate | 0.3-0.6% |
| Colorantes | 0.01-1% |
| FILLING | 15% |
| Organic Tapioca Syrup | 0.1-6% |
| Organic Sugar | 0.1-5% |
| Marine Oil 35/25 | 0.01-3% |
| Usp Glycerin | 0.1-1% |
| Sorbitol 70% | 0.1-1% |
| Citric Acid | 0.1-1% |
| Lactic Acid | 0.01-1% |
| Sabores | 0.1-1% |
| Colorantes | 0.01-1% |
| Potato starch | 0.01-1% |
| Agua | D.O.I |

### Example 5

| RAW MATERIAL (RM) | |
|---|---|
| SHELL | 85% |
| Organic Tapioca Syrup | 30-50% |
| Organic Sugar | 30-50% |
| Water | 12-20% |
| Pectin | 1-3% |
| Citric Acid | 0.1-3% |
| Chamomile Extract | 0.1-5% |
| Sodium Citrate | 0.3-0.6% |
| Flavor | 0.1-2% |
| Saffron Extract | 0.1-5% |
| Wax | 0.01-1% |
| FILLING | 15% |
| Organic Tapioca Syrup | 0.1-6% |
| Mushroom Extracts | 0.1-5% |
| Organic Sugar | 0.1-5% |
| Usp Glycerin | 0.1-1% |
| Sorbitol 70% | 0.01-3% |
| Citric Acid | 0.01-2% |
| Lactic Acid | 0.01-1% |
| Flavors | 0.01-2% |
| Potato Starch | 0.01-1% |
| Colorants | 0.01-1% |
| Agua | D.O.I |

In all the above tables all percentages are by weight.

The active ingredients are being added in the filling and gelled shell. In the filling, to achieve desired viscosity ranges and to guarantee stability of the filling, humectants such as glycerin and/or sorbitol are added. Marine oil extracts are also used as active ingredients that have fatty acids such as Omega 3.

The disclosure above only describes one embodiment of a method of manufacturing a delivery system of the present invention. Other methods and embodiments may be used to manufacture delivery systems in accordance with the present invention. For example, the various steps described in FIG. 1 may be carried out in any suitable order, there being no explicit limitations on the order of the steps set forth above.

All literature and similar materials cited in this application including, but not limited to, patents, patent applications, articles, books, treatises, and internet web pages, regardless of the format of such literature and similar materials, are expressly incorporated by reference in their entirety for any purpose as if they were entirely denoted. In the event that one or more of the incorporated literature and similar materials defines or uses a term in such a way that it contradicts that term's definition in this application, this application controls.

Although the foregoing description contains many specifics, these should not be construed as limiting the scope of the present invention, but merely as providing illustrations of some of the presently preferred embodiments. Similarly, other embodiments may be devised without departing from the spirit or scope of the present invention. Features from different embodiments may be employed in combination. The scope of the invention is, therefore, indicated and limited only by the appended claims and their legal equivalents rather than by the foregoing description. All additions, deletions and modifications to the invention as disclosed herein which fall within the meaning and scope of the claims are to be embraced thereby.

What is claimed is:

1. A method for producing a filled gummy, said filled gummy comprising a gelified shell and a filling encased inside said gelified shell; wherein the filling comprises at least one active ingredient; the method comprising the steps of:
(1) preparing a gelified shell composition by: (i) dissolving a first gelifiable product in water to form a first gelified solution; (ii) optionally adding at least one first sweetener and optionally one or more secondary ingredients to the first gelified solution;
(2) preparing a filling composition, wherein the filling composition comprises at least one bulking agent and one or more active ingredients dissolved or suspended in said filling composition;
(3) depositing the gelified shell composition and the filling composition thereby fully encasing the filling composition within the gelified shell composition;
(4) setting the deposited gelified shell composition; wherein the temperature of the shell is 80-99° C., the temperature of the filling composition upon deposition is 4-20° C., and wherein the viscosity of the shell is 6000-8000 Cp and the viscosity of the filling composition upon deposition ranges between 50000-120000 Cp.

2. The method of claim 1, wherein said gelified shell comprises 85% by weight of the filled gummy.

3. The method of claim 1, wherein said filling composition comprises 15% by weight of the filled gummy.

4. The method of claim 2, wherein said gelified shell composition comprises: 30%-50% by weight organic sweetener syrup; 25%-50% by weight organic sugar, 17%-20% by weight paste cook water; 0.1%-20% by weight actives ingredients, 0.3%-0.6% by weight sodium citrate; 1%-3% by weight pectin; 0.1%-2% by weight flavors; 0.1%-2% by weight natural colors; and 1%-3% by weight of citric acid or lactic acid or malic acid.

5. The method of claim 3, wherein said filling composition comprises: 0.1%-11% by weight sweeteners; 0.1%-2% by weight hydrocolloids; 0.1%-2% by weight flavors; 0.1%-2% by weight natural colors; 0.1%-2% by weight of citric acid or lactic acid or malic acid; and mixing water d.o.i.

6. The method of claim 4, wherein said active ingredients are selected from the group consisting of: nutraceuticals, vitamins, minerals, pharmaceuticals, antioxidants, soluble and insoluble fiber, herbs, plants, probiotics, prebiotics, amino acids, fatty acids, digestive enzymes, dietary supplements, and other health promoting ingredients and mixtures thereof.

7. The method of claim 5, wherein said sweeteners are selected from the group consisting of: sugar, dextrose, glucose syrup, tapioca syrup, sorbitol, maltitol, xylitol, mannitol, chicory, agave inulin, polydextrose, fructo-oligosaccharide, iso-maltooligosaccharide, xylo-oligo-saccharides, stevia and monk fruit.

8. The method of claim 1, wherein said depositing is done onto a starch-coated mold.

9. The method of claim 1, wherein said deposited gummy is cured.

10. A gummy composition comprising a gelified shell and a filling, wherein said gelified shell comprises 85% by weight of the gummy composition and said filling comprises 15% of the composition and wherein said gelified shell composition comprises: 30%-50% by weight organic sweetener syrup; 25%-50% by weight organic sugar; 17%-20% by weight paste cook water; 0.1%-20% by weight actives ingredients; 0.3%-0.6% by weight sodium citrate; 1%-3% by weight pectin; 0.1%-2% by weight flavors; 0.1%-2% by weight natural colors; and 1%-3% by weight of citric acid or lactic acid or malic acid; and wherein said filling composition comprises 0.1%-11% by weight sweeteners; 0.1%-2% by weight hydrocolloids; 0.1%-2% by weight flavors; 0.1%-2% by weight natural colors; 0.1%-2% by weight of citric acid or lactic acid or malic acid; and mixing water d.o.i.

11. The gummy composition of claim 10, wherein said active ingredients are selected from the group consisting of: nutraceuticals, vitamins, minerals, pharmaceuticals, antioxidants, soluble and insoluble fiber, herbs, plants, probiotics, prebiotics, amino acids, fatty acids, digestive enzymes, dietary supplements, and other health promoting ingredients and mixtures thereof.

12. The gummy composition of claim 10, wherein said sweeteners are selected from the group consisting of: sugar, dextrose, glucose syrup, tapioca syrup, sorbitol, maltitol, xylitol, mannitol, chicory, agave inulin, polydextrose, fructo-oligosaccharide, iso-maltooligosaccharide, xylo-oligo-saccharides, stevia and monk fruit.

13. Gummy compositions selected from the group consisting of:
(1)

| RAW MATERIAL (RM) | |
|---|---|
| SHELL | 85% |
| Organic Tapioca Syrup | 30-40% |
| Organic Sugar | 20-40% |
| Paste Cook Water | 15-22% |
| Pectin | 1-3% |
| Citric Acid | 1-3% |
| Vitamin C | 0.1-5% |
| Glazing Agent | 0.1-10% |
| Citrato De Sodio Dihidratado | 0.3-0.6% |
| Sabores | 0.1-2% |
| Zinc Citrate | 0.1-5% |
| Colorantes | 0.01-2% |
| FILLING | 15% |
| Organic Tapioca Syrup | 0.1-6% |
| Organic Sugar | 0.1-5% |
| Usp Glycerin | 0.1-1% |
| Sorbitol 70% | 0.1-1% |
| Acerola Extract | 0.01-3% |
| Citric Acid | 0.01-1% |
| Lactic Acid | 0.01-1% |
| Potato starch | 0.01-2% |
| Colorantes | 0.01-1% |
| Sabores | 0.01-1% |
| Agua | D.O.I |

(2)

| RAW MATERIAL (RM) | |
|---|---|
| SHELL | 85% |
| Organic Tapioca Syrup | 30-50% |
| Organic Sugar | 15-50% |
| Paste Cook Water | 12-20% |
| Honey | 0.1-10% |
| Pectin | 1-3% |
| Citric Acid | 1-2% |
| Vitamin C | 0-1-5% |
| Sodium Citrate | 0.3-0.6% |
| Sabores | 0.01-2% |
| Marshmellow Root Extract | 0.1-3% |
| Zinc | 0.1-2% |
| Colorantes | 0.01-2% |
| FILLING | 15% |
| Honey | 1-15% |
| Pregel Starch | 0.01-2% |

(3)

| RAW MATERIAL (RM) | |
|---|---|
| SHELL | 85% |
| Organic Tapioca Syrup | 30-50% |
| Organic Sugar | 15-50% |
| Paste Cook Water | 15-25% |
| Dark Honey Blend | 0.1-10% |
| Pectin | 1-3% |
| Citric Acid | 1-3% |
| Vitamin C | 0.1-5% |
| Sodium Citrate | 0.3-0.6% |
| Sabores | 0.1-2% |
| Marshmellow Root Extract | 0.1-2% |
| Zinc | 0.01-1% |
| Melatonin | 0.01-1% |
| FILLING | 15% |
| Honey | 1-15% |
| Pregel Starch | 0.01-2% |

(4)

| RAW MATERIAL (RM) | |
|---|---|
| SHELL | 85% |
| Organic Tapioca Syrup | 30-50% |
| Organic Sugar | 15-50% |
| Paste Cook Water | 12-20% |
| Marine Oil 35/25 Tg | 0.1-10% |
| Pectin | 1-3% |
| Citric Acid | 1-3% |
| Sabores | 0.1-2% |
| Sodium Citrate | 0.3-0.6% |
| Colorantes | 0.01-1% |
| FILLING | 15% |
| Organic Tapioca Syrup | 0.1-6% |
| Organic Sugar | 0.1-5% |
| Marine Oil 35/25 | 0.01-3% |
| Usp Glycerin | 0.1-1% |
| Sorbitol 70% | 0.1-1% |
| Citric Acid | 0.1-1% |
| Lactic Acid | 0.01-1% |
| Sabores | 0.1-1% |
| Colorantes | 0.01-1% |
| Potato starch | 0.01-1% |
| Agua | D.O.I |

(5)

| RAW MATERIAL (RM) | |
|---|---|
| SHELL | 85% |
| Organic Tapioca Syrup | 30-50% |
| Organic Sugar | 30-50% |
| Water | 12-20% |
| Pectin | 1-3% |
| Citric Acid | 0.1-3% |
| Chamomile Extract | 0.1-5% |
| Sodium Citrate | 0.3-0.6% |
| Flavor | 0.1-2% |
| Saffron Extract | 0.1-5% |
| Wax | 0.01-1% |
| FILLING | 15% |
| Organic Tapioca Syrup | 0.1-6% |
| Mushroom Extracts | 0.1-5% |
| Organic Sugar | 0.1-5% |
| Usp Glycerin | 0.1-1% |
| Sorbitol 70% | 0.01-3% |
| Citric Acid | 0.01-2% |
| Lactic Acid | 0.01-1% |
| Flavors | 0.01-2% |
| Potato Starch | 0.01-1% |
| Colorants | 0.01-1% |
| Agua | D.O.I |
